(19) United States
(12) Patent Application Publication
(10) Pub. No.: US 2025/0037712 A1
(43) Pub. Date: Jan. 30, 2025

(54) MEASUREMENT APPLICATION DEVICE CONTROL SYSTEM AND METHOD

(71) Applicant: Rohde & Schwarz GmbH & Co. KG, München (DE)

(72) Inventor: Michael FEILEN, Höhenkirchen-Siegertsbrunn (DE)

(21) Appl. No.: 18/360,349

(22) Filed: Jul. 27, 2023

(51) Int. Cl. G10L 15/22; G06F 3/16; G06N 20/00; G10L 15/06; G10L 15/18

(52) U.S. Cl. CPC G10L 15/22; G06F 3/162; G06N 20/00; G10L 15/063; G10L 15/18; G10L 2015/223

(57) ABSTRACT

The present disclosure provides a measurement application device control system comprising a natural language interface configured to receive a natural language task statement, a natural language converter coupled to the natural language interface, and configured to convert the natural language task statement into at least one control command for at least one measurement application device, a command visualizer coupled to the natural language converter and configured to visualize the generated at least one control command, and a confirmation interface configured to receive a confirmation signal indicating that the generated at least one control command represents the received natural language task statement. Further, the present disclosure provides a respective method.

### TECHNICAL FIELD

The disclosure relates to a measurement application device control system and a respective method.

### BACKGROUND

Although applicable to any type of measurement application device, the present disclosure will mainly be described in conjunction with laboratory equipment, like spectrum analyzers and signal generators.

When setting up measurement equipment for a specific measurement application, a user may manually set-up the single measurement application devices step-by-step. As alternative, the user may also employ scripts to set-up the single measurement application devices. The scripts may further be used to control the measurement application devices while performing one or multiple measurements.

Such scripts may comprise e.g., SCPI scripts or other adequate scripts, that a user may write. Writing such control scripts may be a cumbersome task.

Accordingly, there is a need for simplifying control of measurement application devices.

### SUMMARY

The above stated problem is solved by the features of the independent claims. It is understood, that independent claims of a claim category may be formed in analogy to the dependent claims of another claim category.

Accordingly, it is provided:

A measurement application device control system comprising a natural language interface for receiving a natural language task statement, a natural language converter coupled to the natural language interface and configured to convert the natural language task statement into at least one control command for at least one measurement application device, a command visualizer coupled to the natural language converter and configured to visualize the generated at least one control command, and a confirmation interface configured to receive a confirmation signal e.g., from a user, indicating that the generated at least one control command represents the received natural language task statement.

Further, it is provided:

A measurement application device control method comprising receiving a natural language task statement, converting the natural language task statement into at least one control command for at least one measurement application device, visualizing the generated at least one control command, and receiving a confirmation signal e.g., from a user, indicating if the generated at least one control command represents the received natural language task statement or not.

The present patent application is based on the finding that writing complex control scripts for measurement application devices e.g., SCPI scripts for network-enabled laboratory measurement application devices, is a complex task. Especially, while setting-up and wiring the hardware arrangement for a measurement application, a user may be distracted. This will make it difficult to write the respective control script.

This may also apply to direct control of the respective measurement application devices by the user, especially, if multiple measurement application devices, like signal generators and measurement devices, are used at the same time in a measurement application.

The present disclosure, therefore, provides the measurement application device control system that allows a user to control one or more measurement application devices with natural language commands instead of manually written control scripts, like SCPI scripts. SCPI in the context of this disclosure refers to the “Standard Commands for Programmable Instruments” scripting standard that was defined as an additional layer on top of the IEEE 488.2-1987 specification “Standard Codes, Formats, Protocols, and Common Commands”. The at least one control command may be a command according to the SCPI standard.

The measurement application device control system comprises a natural language interface that may receive one or more natural language task statements e.g., directly from a user of the measurement application device control system.

The natural language task statement in an exemplary embodiment may comprise the natural language definition of a task that is to be performed with the at least one measurement application device as a human would formulate or voice the command.

Exemplary natural language task statements may be formulated e.g., as follows: “On the spectrum analyzer, measure 100 Points from 1 GHz to 10 GHz with a bandwidth of 1 MHz at the blue connector”, or “On the vector signal generator, set the output power to 10 dBm, generate a CW [” continuous wave “] tone and sweep the frequency in steps of 1 MHz from 1 GHz to 10 GHz”.

A user may provide only a single natural language task statement referring to a single measurement application device. In embodiments, the natural language task statement may also refer to multiple measurement application devices at the same time.

In exemplary applications, the natural language interface may receive natural language task statements from a user that each refer to the configuration of a single measurement application device. After receiving the single-device natural language task statements, the natural language interface may receive a general natural language task statement to initiate a measurement, that may then influence multiple measurement application devices at the same time based on the single-device natural language task statements.

The natural language converter receives the single natural language task statements, and converts each received natural language task statement into a respective control command or a sequence of control commands for a respective measurement application device or multiple measurement application devices.

As indicated above, the control commands may in embodiments be provided based on a command standard, like the SCPI standard. In other embodiments, the control commands may be provided in any other format, for example, in a variant of the SCPI standard or a proprietary format defined by the vendor of a respective measurement application device. The proprietary format may comprise e.g., a binary command format. The format my also comprise a sequence of remote access commands that may be executed to remotely control one or more measurement application devices. Such remote access commands may e.g., comprise calls to REST-API endpoints that are provided by the one or more measurement application devices.

After generating the at least one control command, the command visualizer visualizes the generated control commands. The visualization of the generated control commands serves for a user to verify that the natural language task statement that was provided is correctly translated into the at least one control command. With the command visualizer, a user may visually inspect the generated at least one control command easily.

After inspection by the user, the measurement application device control system may receive a confirmation signal from the user via the confirmation interface, the confirmation signal indicating that the generated at least one control command represents the natural language task statement as provided to the natural language interface.

It is understood, that the confirmation signal may be provided as a single value signal. In such an embodiment, receiving the confirmation signal indicates that the at least one control command is acceptable, and not receiving the confirmation signal indicates that the at least one control command is not acceptable. In other embodiments, the confirmation signal may be a binary or two-value signal. Such a confirmation signal may be provided as positive signal that indicates that the at least one control command is acceptable, or a negative signal that indicates that the at least one control command is not acceptable.

After receiving a confirmation signal that indicates that the at least one control command is generated as intended i.e., represents the received natural language task statement, the user may then continue his work on the respective measurement application based on the at least one control command.

The single components of the measurement application device control system may be provided in different configurations as any possible combination of hardware and software components.

Especially, the natural language interface, the natural language converter, and the command visualizer may at least in part comprise or may be provided in or as part of at least one of a dedicated processing element e.g., a processing unit, a microcontroller, a field programmable gate array, FPGA, a complex programmable logic device, CPLD, an application specific integrated circuit, ASIC, or the like. A respective program or configuration may be provided to implement the required functionality. The natural language interface, the language converter, and the command visualizer may at least in part also be provided as a computer program product comprising computer readable instructions that may be executed by a processing element. In a further embodiment, the natural language interface, the language converter, and the command visualizer may be provided as addition or additional function or method to the firmware or operating system of a processing element that is already present in the respective application as respective computer readable instructions. Such computer readable instructions may be stored in a memory that is coupled to or integrated into the processing element. The processing element may load the computer readable instructions from the memory and execute them.

In addition, it is understood, that any required supporting or additional hardware may be provided like e.g., a power supply circuitry and clock generation circuitry.

The natural language interface, and the confirmation interface may in embodiments be provided as hardware interfaces. In other embodiments, the natural language interface, and the confirmation interface may be provided as API-interfaces, or program-based or function-based interfaces.

The natural language task statement may, for example, be provided as spoken language or written text to a hardware interface, or as audio data or text data to an API-interface, or a program-based or function-based interface. The same applies to the confirmation interface, where the confirmation signal may be provided via a hardware input, or via an API-interface, or a program-based or function-based interface.

The term “hardware input” with regard to the present disclosure is to be understood as any type of input that may be user or actuated by a user. Such inputs may comprise microphones, hardware push buttons, inputs on a touch screen, or any other input device, like a mouse and a keyboard.

Possible implementations of the confirmation signal include, but are not limited to, a button, like an “OK” or “Confirm” button, and a “Decline” or “Reject” button. Such buttons may be implemented as hardware or as virtual buttons e.g., on a touch screen.

Further, any interface that is designed to receive input from a user may be provided in a measurement application device, or as dedicated interface. In embodiments, such interfaces may be provided as input elements on a screen that represents the respective interface, for example input elements on a touch screen or on an HTML-based website rendered in a web browser application on the screen of a user device.

A measurement application device according to the present disclosure may comprise any device that may be used in a measurement application to acquire an input signal or to generate an output signal, or to perform additional or supporting functions in a measurement application. A measurement application device may also comprise or be implemented as application or applications, also called measurement application or measurement applications, that may be executed on a computer device and that may communicate with other measurement application devices in order to perform a measurement task. A measurement application, also called measurement setup, may e.g., comprise at least one or multiple different measurement application devices for performing electric, magnetic, or electromagnetic measurements, especially on single devices under test. Such electric, magnetic, or electromagnetic measurements may be performed in a measurement laboratory or in a production facility in the respective production line. A measurement application or measurement setup may serve to qualify the single devices under test i.e., to determine the proper electrical operation of the respective devices under test.

Measurement application devices to this end may comprise at least one signal acquisition section for acquiring electric, magnetic, or electromagnetic signals to be measured from a device under test, or at least one signal generation section for generating electric, magnetic, or electromagnetic signals that may be provided to the device under test. Such a signal acquisition section may comprise, but is not limited to, a front-end for acquiring, filtering, and attenuating or amplifying electrical signals. The signal generation section may comprise, but is not limited to, respective signal generators, amplifiers, and filters.

Further, when acquiring signals, measurement application devices may comprise a signal processing section that may process the acquired signals. Processing may comprise converting the acquired signals from analog to digital signals, and any other type of digital signal processing, for example, converting signals from the time-domain into the frequency-domain.

The measurement application devices may also comprise a user interface to display the acquired signals to a user and allow a user to control the measurement application devices. Of course, a housing may be provided that comprises the elements of the measurement application device. It is understood, that further elements, like power supply circuitry, and communication interfaces may be provided.

A measurement application device may be a stand-alone device that may be operated without any further element in a measurement application to perform tests on a device under test. Of course, communication capabilities may also be provided for the measurement application device to interact with other measurement application devices.

A measurement application device may comprise, for example, a signal acquisition device e.g., an oscilloscope, especially a digital oscilloscope, a spectrum analyzer, or a vector network analyzer. Such a measurement application device may also comprise a signal generation device e.g., a signal generator, especially an arbitrary signal generator, also called arbitrary waveform generator, or a vector signal generator. Further possible measurement application devices comprise devices like calibration standards, or measurement probe tips.

Of course, at least some of the possible functions, like signal acquisition and signal generation, may be combined in a single measurement application device.

In embodiments, the measurement application device may comprise pure data acquisition devices that are capable of acquiring an input signal and of providing the acquired input signal as digital input signal to a respective data storage or application server. Such pure data acquisition devices not necessarily comprise a user interface or display. Instead, such pure data acquisition devices may be controlled remotely e.g., via a respective data interface, like a network interface or a USB interface. The same applies to pure signal generation devices that may generate an output signal without comprising any user interface or configuration input elements. Instead, such signal generation devices may be operated remotely via a data connection.

With the solution of the present disclosure, a user may easily generate control scripts or control programs comprising a plurality of control commands to control one or more measurement application devices without manually writing the respective scripts or control programs.

The natural language converter will, especially, support the user in generating the control commands as required by the respective measurement application devices. Even when using a standard scripting language, like provided by the SCPI standard, single measurement application devices will still use individual parameters or variants of the standard commands that may not all be known to a user. When using a non-standard set of control commands, like an individual REST-API, it is even more difficult for a user to know all possible commands.

In the measurement application device control system, the natural language converter may be provided with information about every possible measurement application device, and may then generate the at least one control command using individual parameters or variants of the control commands for every measurement application device.

Consequently, the users of the measurement application device control system do not need to memorize individual commands for the single measurement application devices, and may still generate the respective control commands to perform a measurement task in the respective measurement application.

Further embodiments of the present disclosure are subject of the further dependent claims and of the following description, referring to the drawings.

In the following, the dependent claims referring directly or indirectly to claim 1 are described in more detail. For the avoidance of doubt, the features of the dependent claims relating to the system can be combined in all variations with each other and the disclosure of the description is not limited to the claim dependencies as specified in the claim set. Further, the features of the other independent claims may be combined with any of the features of the dependent claims relating to the system in all variations, wherein respective method steps implement the functionality of the respective system or apparatus elements.

In an embodiment, which can be combined with all other embodiments of the system mentioned above or below, the measurement application device control system may further comprise a device control interface configured to control the at least one measurement application device based on the generated at least one control command.

The device control interface may be provided in different configurations.

If the measurement application device control system is provided in a measurement application device, the function of the measurement application device control system may be implemented as software or program code comprising instructions that control a processor of the measurement application device and access hardware elements of the measurement application device, like a microphone, and a touchscreen.

The device control interface may in such embodiments be provided as API-interface, or a program-based or function-based interface, that internally communicates with other components of e.g., an operating system or firmware, of the measurement application device.

If the measurement application device control system is provided as dedicated system or in a dedicated device, or if a measurement application device control system in a measurement application device is used to control further measurement application devices, the measurement application device control system may at least in part comprise respective hardware interfaces. The device control interface may e.g., be provided as a network interface and a respective program or module that uses the network interface to communicate with the respective measurement application devices. The device control interface may also comprise a combination of an API-interface, or a program-based or function-based interface, and the hardware-based interface

Possible communication interfaces may comprise, but are not limited to, any kind of wired and wireless communication interfaces, like for example a network communication interface, especially an Ethernet, wireless LAN or WIFI interface, a USB interface, a Bluetooth interface, an NFC interface, a visible or non-visible light-based interface, especially an infrared interface.

The device control interface may control other measurement application devices based on the generated at least one control command. To this end, the device control interface may send the full set of generated control commands to the respective measurement application device, or may individually transmit the single control commands, and, where appropriate or required, wait for respective confirmations from the respective measurement application device. This may e.g., be required for commands that initiate a function with a specific runtime in a measurement application device, wherein further control commands may only be received after the respective function finished to execute.

In a further embodiment, which can be combined with all other embodiments of the system mentioned above or below, the device control interface may be configured to control the at least one measurement application device after a respective execution command is received via at least one of the natural language interface and the confirmation interface.

With the execution command, a user may individually control the execution of the generated at least one control command.

Instead of automatically providing the generated at least one control command to a measurement application device after receiving the confirmation signal, a user may initiate the execution of the at least one control command when needed via the execution command.

In embodiments, multiple natural language task statements may be provided via the natural language interface. Therefore, multiple groups or sets of at least one control command may be present in the measurement application device control system.

The single groups or sets may be numbered. Alternatively, or in addition, the user may provide every natural language task statement with a respective ID or keyword that may be stored in the measurement application device control system together with the groups or sets of the at least one control command.

When providing the execution command, the user may include the respective number, ID or keyword in the execution command. The device control interface will then use the respective group or set of at least one control command to control the respective at least one measurement application device.

In another embodiment, which can be combined with all other embodiments of the system mentioned above or below, the measurement application device control system may further comprise a trigger interface configured to receive a trigger signal and activate the natural language interface after receiving the trigger signal.

The trigger interface may comprise any type of interface, like a push-button, a switch, a gesture-based interface, a video-based interface, or a natural language-based interface. If the trigger signal is received via the trigger interface, the trigger interface will activate the natural language interface to await the natural language task statement.

Without the trigger interface, the natural language interface would be always activated. Especially, in the case of a natural language audio interface, the natural language interface would in such a configuration record audio that is not intended to be a natural language task statement. This could lead to the generation of random and erroneous control commands.

Therefore, the trigger signal is used to only activate the natural language interface when needed.

It is understood, that in cases where the trigger interface, and the natural language interface are of the same type e.g., audio interfaces, the same hardware input e.g., a microphone, may be used by the trigger interface, and the natural language interface. The further functionality of the trigger interface, and the natural language interface may then be implemented e.g., as computer program product with respective instructions.

In embodiments, where the trigger interface comprises a video-based interface, the trigger signal may be detected when a user looks at a specific spot or section of e.g., a measurement application device. For a gesture-based trigger interface, predetermined gestures, especially hand or finger gestures may be defined, or a user may be allowed to define his own gestures that the trigger interface may record and store.

In another further embodiment, which can be combined with all other embodiments of the system mentioned above or below, the natural language interface may comprise an audio interface and an audio converter that is coupled to the audio interface and that is configured to convert the received audio signal into a statement representation that is processable by the natural language converter.

As explained above, the natural language interface, and in embodiments also the trigger interface, may comprise a text-based natural language interface. In this case, no microphone is required, since the text may be provided e.g., via a keyboard or a touchscreen, or a data communication interface.

However, with the audio interface, the natural language task statement may be provided as spoken language. The audio interface may comprise a microphone. The audio signal received by the audio interface is then provided to the audio converter that converts the audio signal into a statement representation that may be processed by the natural language converter.

In embodiments, the natural language converter may be configured to process natural language statements. In these types of embodiments, the audio converter of the audio interface may convert the received audio signal into text that represents the spoken words. The audio converter may be provided as a so-called speech-to-text converter, or speech-to-text engine.

In other embodiments, the natural language converter may be configured to process a representation of the natural language task statement that does not resemble spoken words any more. In such embodiments, the audio converter may be configured to convert the received audio signal into the respective representation.

In an embodiment, which can be combined with all other embodiments of the system mentioned above or below, the natural language interface or the confirmation interface may be configured to receive a correction command, and the natural language converter may be configured to re-generated the at least one control command based on the received correction command.

The correction command may be received via any one of the natural language interface, or the confirmation interface. In embodiments an additional interface may be provided for receiving the correction command.

The correction command may be provided by a user if the generated at least one command does not represent the natural language task statement correctly. The correction command, in contrast to a negative confirmation command, does not lead to discarding of the generated at least one control command. Instead, the correction command will trigger a re-generation of the at least one control command based on the natural language task statement.

The correction command may not only indicate that the at least one control command is not correct. Instead, the correction command may also indicate how the at least one control command is wrong or how the at least one control command should be corrected.

With this information the natural language converter may not simply regenerate the at least one control command based on the same information that was already at hand at the first run. Instead, additional information is available, and the natural language converter may generate an improved at least one control command.

The correction command may also be used by a user to amend a basically correct at least one control command. This may be used by the user to add functionality that he forgot to specify in the natural language task statement.

If the user e.g., provided a natural language task statement that initiates a measurement in a vector network analyzer, the user may e.g., correct or provide for the first time a number of points or step width for the measurement. The user may e.g., provide the natural language task statement “On the spectrum analyzer, measure 1 GHz to 10 GHz with a bandwidth of 1 MHZ”. The correction command may then e.g., be “measure 100 points and use the blue connector of the spectrum analyzer”.

In another embodiment, which can be combined with all other embodiments of the system mentioned above or below, the natural language converter may comprise an algorithm that comprises at least one of an artificial-intelligence-based algorithm, and a trained algorithm.

The natural language converter may in embodiments comprise an AI or artificial-intelligence-based algorithm that is trained to generate the at least one control command.

Such an AI or artificial-intelligence-based algorithm may be based on a large language model, like a transformer network, especially a generative pre-trained transformer or GPT network.

Such networks may be pretrained for a specific task, like generating the at least one control command based on respective natural language task statements. To this end, training data may be provided that comprises natural language task statements and the respective expected at least one control command. The training of such AI-based algorithms will not be described in detail, while reference is made to well-known training techniques.

Therefore, using an AI or artificial-intelligence-based algorithm allows directly generating the at least one control command from a natural language task statement that is spoken by a user and converted into respective text by the natural language converter.

In a further embodiment, which can be combined with all other embodiments of the system mentioned above or below, the measurement application device control system may further comprise an algorithm trainer, wherein the natural language interface may be configured to receive a correction command, and the algorithm trainer may be configured to re-train or fine-tune the algorithm based on the correction command.

The AI or artificial-intelligence-based algorithm may be a foundational GPT model that is specifically adapted to generate the at least one control command.

Such a model may be re-trained or fine-tuned without repeating the full training. Instead, fine-tuning of the model may be performed based on a presently available model. For fine-tuning e.g., a combination of supervised training and reinforcement learning from human feedback may be used. The human feedback may be the correction command provided by a user.

The fine-tuning or re-training may e.g., be based on the difference between the intended outcome i.e., the problems described in the correction command, and the originally generated at least one control command.

In embodiments, after or in parallel to fine-tuning or re-training, the at least one control command may be regenerated.

In another embodiment, which can be combined with all other embodiments of the system mentioned above or below, the measurement application device control system may further comprise a display device configured to display a representation of the generated at least one control command.

The display device may in embodiments comprise a display and a respective display control function or display control program. When integrated into a measurement application device, the display of the display device may be a display of the measurement application device.

The display control function or display control program may be provided as hardware, or as software that may be executed in any processing element of the measurement application device control system, or of a respective measurement application device. The display control function or display control program may e.g., draw respective elements on the display.

The conversion of the at least one control command into a visual representation may be performed e.g., in the natural language converter or in the display control function or program. The natural language converter may e.g., output a respective string that represents a graphic file e.g., an SVG file, that shows the visualization.

In a further embodiment, which can be combined with all other embodiments of the system mentioned above or below, the representation of the generated at least one control command may comprise at least one of a text representation, a flow diagram, and a block diagram.

In an embodiment, the at least one control command may be displayed as text on the display device. In another embodiment, a block diagram or flow diagram of the at least one control command may be displayed on the display device. In embodiments, a combination of the text representation of the at least one control command and flow or block diagram may be shown.

The block or flow diagram, in embodiments, may represent or comprise references to the functional block diagrams of the respective measurement application devices that are used by or controlled with the at least one control command.

In embodiments, the visual representation may also comprise links to the device documentation of the respective measurement application devices for the single control commands that allow the user to verify the respective control command.

In an embodiment, which can be combined with all other embodiments of the system mentioned above or below, the measurement application device control system may further comprise a central processing element, wherein at least one of the natural language interface, the natural language converter, the command visualizer, and the confirmation interface may at least in part be provided as computer programs comprising computer readable instructions that are executed by the central processing element.

The central processing element may be the main processor of a measurement application device. The measurement application device control system may in such embodiments be implemented in the respective measurement application device. Other measurement application devices may be controlled via a network interface of the respective measurement application device.

In other embodiments, the central processing element may be provided in a server. The server may be a dedicated server that may be implemented as a single hardware device. The server may also be implemented as a distributed system comprising a plurality of servers, optionally with a load balancer, that distributes the load over the servers. The server may also be provided as a so-called cloud or cloud-server system that implements the server via virtualization methods independently of the underlying hardware.

Especially, when provided with a remote or network-attached server, the measurement application device control system may provide a user interface that is displayed remotely on the display of a measurement application device or any other adequate device of a user.

Such a display may e.g., be provided as HTML-based website, wherein interactive functions may be provided via JavaScript on said website. As alternative, a dedicated application may be executed on the respective remote device e.g., a measurement application device or a user device, like a Tablet PC.

When using a remote server, the natural language interface may at least in part be provided in the measurement application device, or the user device. For example, a microphone may be provided in the measurement application device, or the user device together with a function to transmit recorded audio to the server. Such functionality may also be provided in the above-mentioned HTML website with the help of JavaScript.

When used with a remote server, either a dedicated server or a distributed or cloud server, any element of the measurement application device control system may be partitioned as adequate. For example, the processing functions may be performed on the server, while all frontend and recording or user interaction functions may be provided on a user device or the respective measurement application device as native application or as HTML-based website.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a block diagram of an embodiment of a measurement application device control system according to the present disclosure;

FIG. 2 shows a block diagram of another embodiment of a measurement application device control system according to the present disclosure;

FIG. 3 shows a block diagram of another embodiment of a measurement application device control system according to the present disclosure;

FIG. 4 shows a block diagram of another embodiment of a measurement application device control system according to the present disclosure;

FIG. 5 shows a block diagram of another embodiment of a measurement application device control system according to the present disclosure;

FIG. 6 shows a block diagram of another embodiment of a measurement application device control system according to the present disclosure;

FIG. 7 shows a block diagram of another embodiment of a measurement application device control system according to the present disclosure;

FIG. 8 shows a flow diagram of an embodiment of a measurement application device control method according to the present disclosure;

FIG. 9 shows a flow diagram of another embodiment of a measurement application device control method according to the present disclosure;

FIG. 10 shows a flow diagram of another embodiment of a measurement application device control method according to the present disclosure;

FIG. 11 shows a flow diagram of another embodiment of a measurement application device control method according to the present disclosure;

FIG. 12 shows a block diagram of an embodiment of an oscilloscope that may be used with a measurement application device control system according to the present disclosure;

FIG. 13 shows a block diagram of another embodiment of an oscilloscope that may be used with a measurement application device control system according to the present disclosure.

In the figures like reference signs denote like elements unless stated otherwise.

### DETAILED DESCRIPTION OF THE DRAWINGS

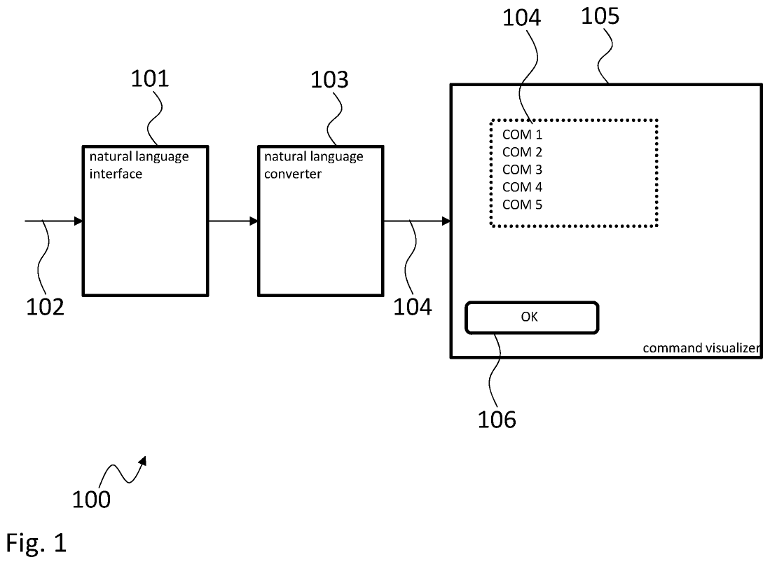

FIG. 1 shows a measurement application device control system 100. The measurement application device control system 100 comprises a natural language interface 101 that is coupled to a natural language converter 103. The natural language converter 103 is coupled to a command visualizer 105. The measurement application device control system 100 further comprises a confirmation interface 106.

The natural language interface 101 receives a natural language task statement 102, and provides the natural language task statement 102 to the natural language converter 103. The natural language converter 103 converts the natural language task statement 102 into at least one control command 104 for at least one measurement application device (not shown).

In the measurement application device control system 100, the confirmation interface 106 is provided as a button on a user interface that is shown on a screen. In other embodiments, the confirmation interface 106 may be a hardware button or an audio interface. The confirmation interface 106 may in embodiments be integrated into or be part of the natural language interface 101. With such a confirmation interface 106, a user may speak to the natural language interface 101 to provide the confirmation signal.

The measurement application device control system 100, or at least the elements of the measurement application device control system 100 that do not require physical interaction with external entities, like a user, may be provided as a computer program product comprising computer readable instructions that cause a processor to perform the functions of the single elements of the measurement application device control system 100 when executed by the processor.

In an embodiment, the measurement application device control system 100 may e.g., be implemented in a measurement application device, like an oscilloscope or a vector network analyzer. In such an embodiment, the natural language interface may comprise a microphone of the measurement application device, and a converter that converts the recorded audio signal into a signal that may be further processed e.g., a string representation of the spoken words. The natural language converter 103 may be provided as pure computer program product executed on a processor of the measurement application device, while the command visualizer 105 may be implemented as a combination of a computer program product and a display of the measurement application device.

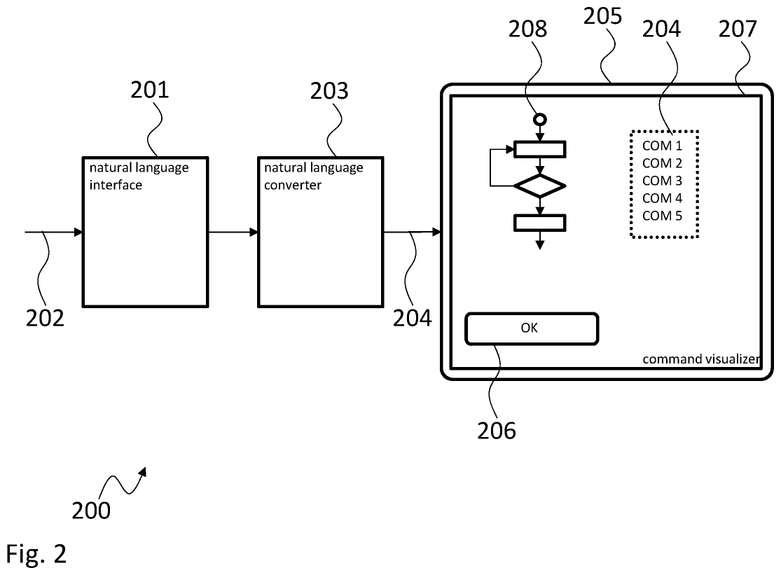

FIG. 2 shows a block diagram of another measurement application device control system 200. The measurement application device control system 200 is based on the measurement application device control system 100. Therefore, the measurement application device control system 200 comprises a natural language interface 201 that is coupled to a natural language converter 203. The natural language converter 203 is coupled to a command visualizer 205. The measurement application device control system 200 further comprises a confirmation interface 206. The explanations provided above for the measurement application device control system 100 apply mutatis mutandis to the measurement application device control system 200.

The measurement application device control system 200 further comprises a display device 207 for the command visualizer 205. In the display the generated control commands 204 are shown as text representation. Further, a flow diagram representation 208 that represents the control commands 204 is shown on the display device 207.

With the flow diagram representation 208, a user may easily assess if the generated control commands 204 correctly implement the natural language task statement 202 that he provided.

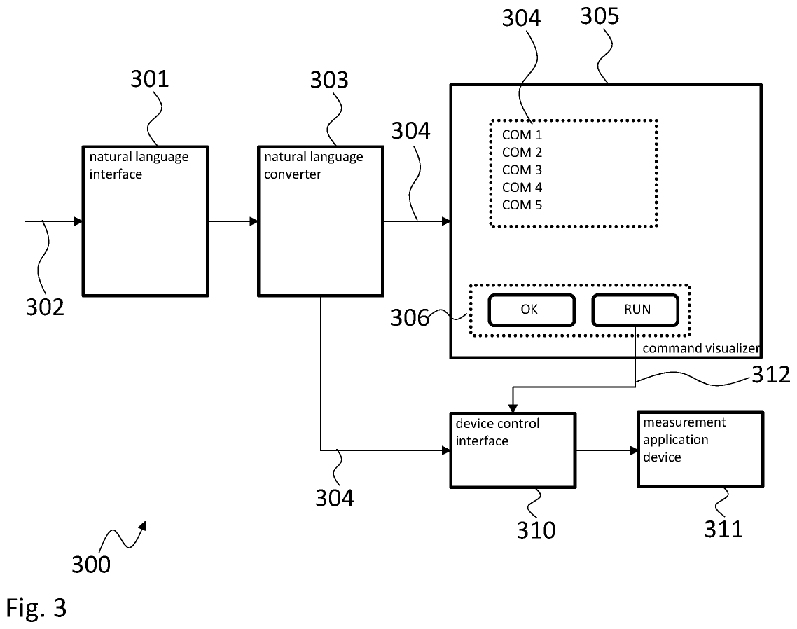

FIG. 3 shows a block diagram of another measurement application device control system 300. The measurement application device control system 300 is based on the measurement application device control system 100. Therefore, the measurement application device control system 300 comprises a natural language interface 301 that is coupled to a natural language converter 303. The natural language converter 303 is coupled to a command visualizer 305. The measurement application device control system 300 further comprises a confirmation interface 306. The explanations provided above for the measurement application device control system 100 apply mutatis mutandis to the measurement application device control system 300.

The measurement application device control system 300 further comprises a device control interface 310 that is coupled to the natural language converter 303 and receives the control commands 304. In addition, the confirmation interface 306 comprises two buttons, a first button labeled “OK”, and a second button labeled “RUN”. With the second button, a user may input an execution command 312.

When the execution command 312 is received at the device control interface 310, the device control interface 310 starts controlling at least one measurement application device 311 based on the control commands 304.

In embodiments, the measurement application device control system 300 may be implemented in the measurement application device 311, and control the single elements of the measurement application device 311 via respective programming interfaces or APIs in the firmware or operating system of the measurement application device 311.

In other embodiments, the measurement application device control system 300 may be communicatively coupled to the measurement application device 311 e.g., via a data network, and control the measurement application device 311 remotely.

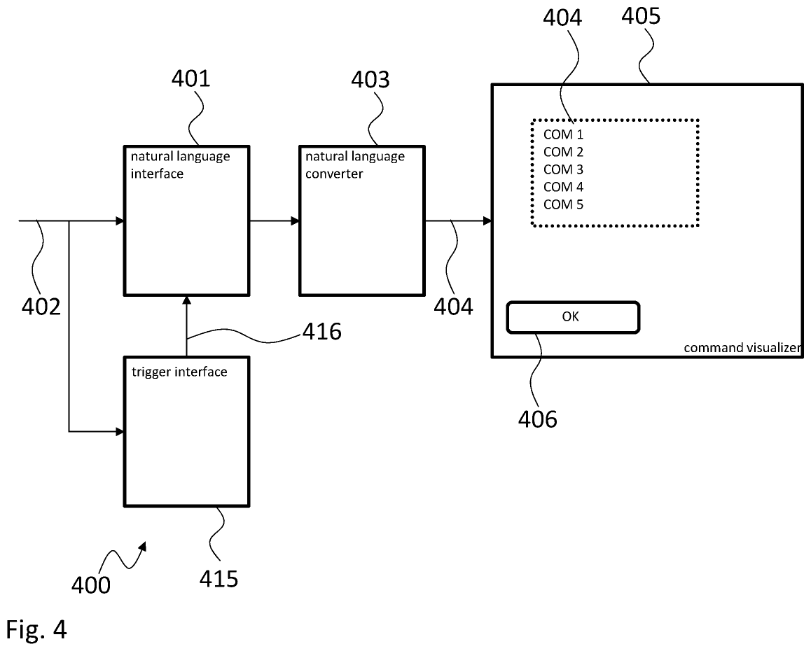

FIG. 4 shows a block diagram of another measurement application device control system 400. The measurement application device control system 400 is based on the measurement application device control system 100. Therefore, the measurement application device control system 400 comprises a natural language interface 401 that is coupled to a natural language converter 403. The natural language converter 403 is coupled to a command visualizer 405. The measurement application device control system 400 further comprises a confirmation interface 406. The explanations provided above for the measurement application device control system 100 apply mutatis mutandis to the measurement application device control system 400.

The measurement application device control system 400 further comprises a trigger interface 415 for receiving a trigger signal 416. In the measurement application device control system 400, the natural language interface 401 may be disabled in a default state. After receiving a respective user input, the trigger interface 415 may generate the trigger signal 416, and provide the trigger signal 416 to the natural language interface 401. After receiving the trigger signal 416, the natural language interface 401 may start operating and receiving the natural language task statement 402.

In the measurement application device control system 400, the user input may be a spoken user input for the natural language interface 401, as well as for the trigger interface 415.

In other embodiments, the user input for the trigger interface 415 may be another type of user input e.g., a gesture input, or an input provided via a switch or a button on a touchscreen.

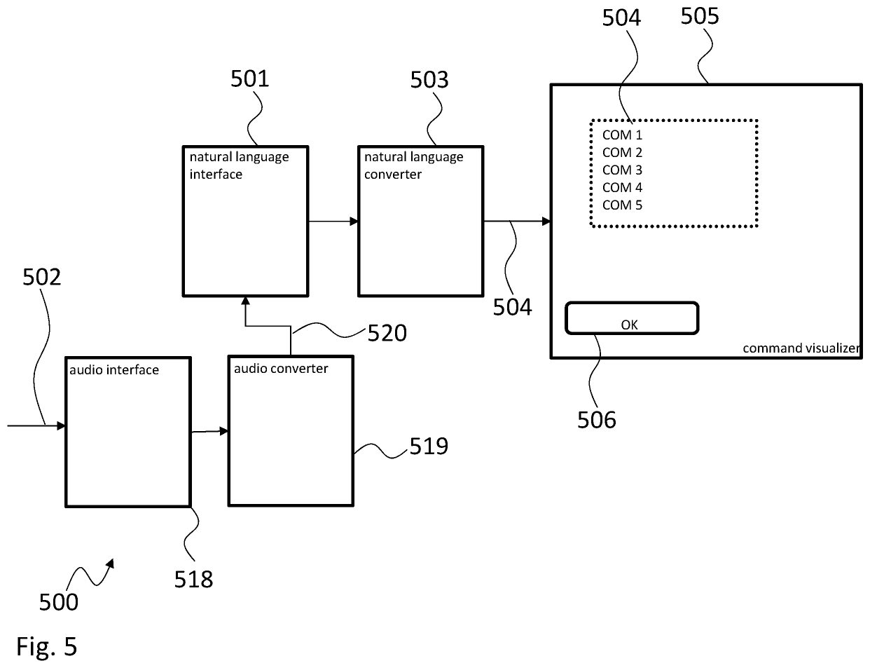

FIG. 5 shows a block diagram of another measurement application device control system 500. The measurement application device control system 500 is based on the measurement application device control system 100. Therefore, the measurement application device control system 500 comprises a natural language interface 501 that is coupled to a natural language converter 503. The natural language converter 503 is coupled to a command visualizer 505. The measurement application device control system 500 further comprises a confirmation interface 506. The explanations provided above for the measurement application device control system 100 apply mutatis mutandis to the measurement application device control system 500.

The measurement application device control system 500 further comprises an audio interface 518 that is coupled to an audio converter 519. The audio converter 519 is coupled to the natural language interface 501 to provide the natural language interface 501 with a statement representation of a spoken natural language task statement 502 that may be processed by the natural language interface 501.

The audio interface 518 may e.g., comprise a microphone installed in a measurement application device, or in another user device, like a PC or tablet computer. The audio converter 519 may comprise a speech-to-text algorithm that converts spoken words recorded as audio data into a text representation of the spoken words.

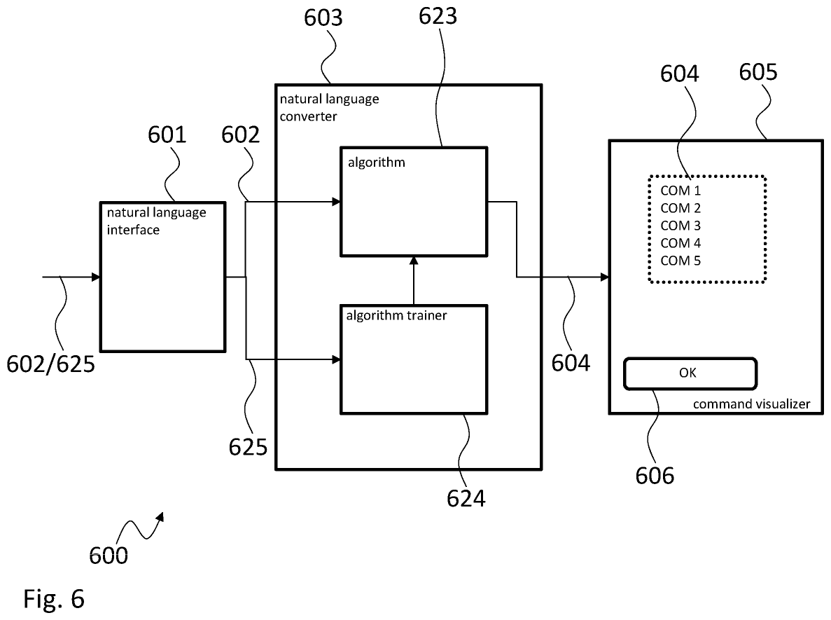

FIG. 6 shows a block diagram of another measurement application device control system 600. The measurement application device control system 600 is based on the measurement application device control system 100. Therefore, the measurement application device control system 600 comprises a natural language interface 601 that is coupled to a natural language converter 603. The natural language converter 603 is coupled to a command visualizer 605. The measurement application device control system 600 further comprises a confirmation interface 606. The explanations provided above for the measurement application device control system 100 apply mutatis mutandis to the measurement application device control system 600.

The natural language converter 603 of the measurement application device control system 600 further comprises an algorithm 623, and an optional algorithm trainer 624.

The algorithm 623 may, especially, comprise an artificial intelligence or AI-based algorithm. Possible algorithms comprise Generative Pre-trained Transformer or GPT algorithms.

With the measurement application device control system 600, a user may provide a correction command 625. The correction command 625 may be issued by a user to modify the generated control commands 604 e.g., to add further parameters or functions.

Further, the user may optionally also indicate with the correction command 625 that the control commands 604 are not generated correctly. The user may also indicate the correct or expected control commands 604. With this information, the algorithm trainer 624 may re-train or fine-tune the algorithm 623.

The specific details of the algorithm trainer 624 are not explained here, since they depend strongly on the selected type of algorithm 623. However, the algorithm trainer 624 will in any embodiment be chosen to match the algorithm 623.

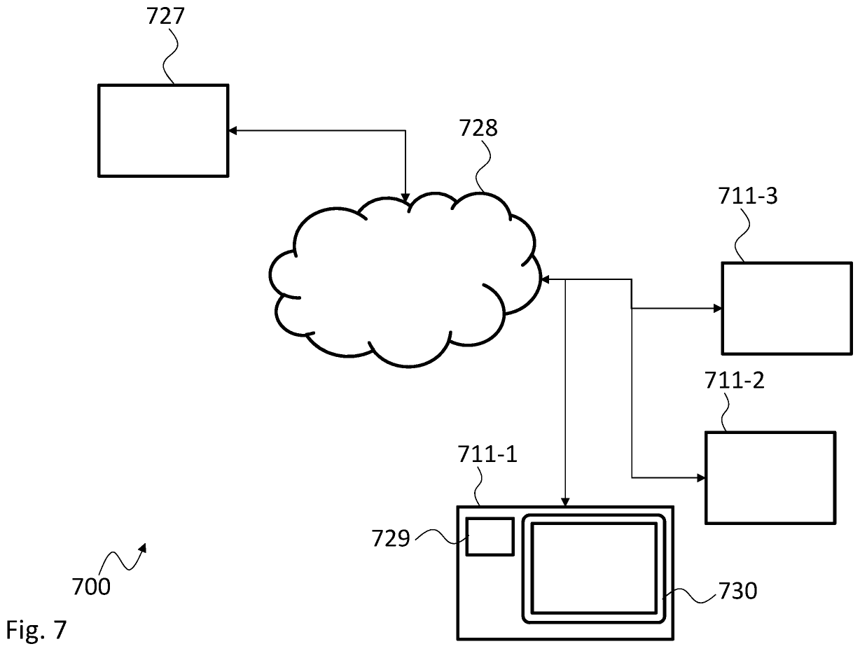

FIG. 7 shows a block diagram of another measurement application device control system 700. The measurement application device control system 700 may comprise any of any one of the features of the measurement application device control systems disclosed herein.

The measurement application device control system 700 comprises a central processing element 727 that is coupled to a network 728. The network 728 is further coupled exemplarily to three measurement application devices 711-1, 711-2, 711-3.

In the measurement application device control system 700, the functions and elements of the measurement application device control system 700 are distributed between the central processing element 727, and the measurement application device 711-1.

The natural language interface is provided as a microphone 729 of the measurement application device 711-1, and the command visualizer is shown on the touchscreen 730 of the measurement application device 711-1.

The natural language converter is provided as computer program product in the central processing element 727.

The central processing element 727, and the measurement application devices 711-1, 711-2, 711-3 may be coupled through any type of communication interfaces. It is understood, that the communication interface may comprise any kind of wired and wireless communication interfaces, like for example a network communication interface, especially an Ethernet, wireless LAN or WIFI interface, a USB interface, a Bluetooth interface, an NFC interface, a visible or non-visible light-based interface, especially an infrared interface.

It is further understood, that the network 728 may comprise any type of network devices, like switches, hubs, routers, firewalls, and different types of network technologies.

The central processing element 727 may be provided as dedicated server. Alternatively, the central processing element 727 may also be provided as distributed, or virtualized, or cloud server.

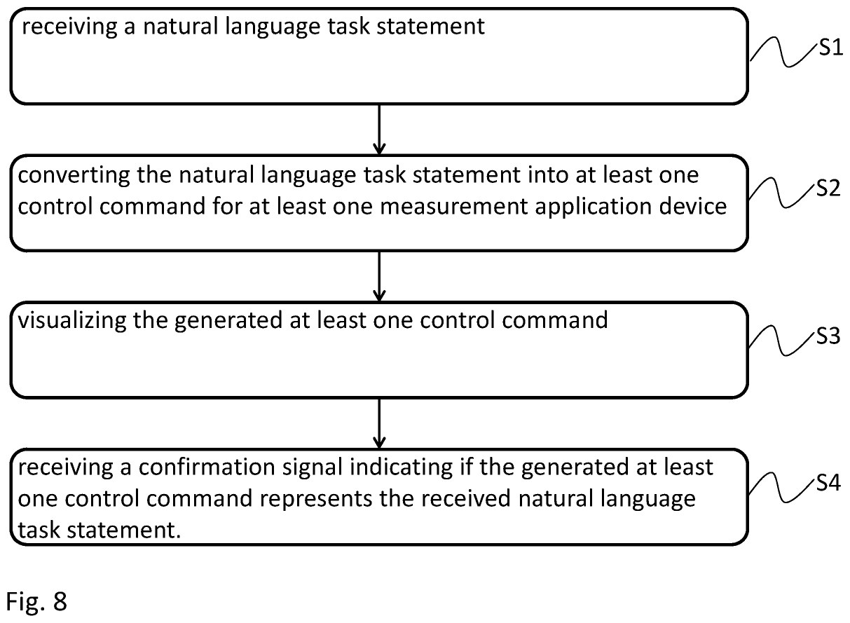

FIG. 8 shows a flow diagram of a measurement application device control method.

The method comprises receiving S1 a natural language task statement, converting S2 the natural language task statement into at least one control command for at least one measurement application device, visualizing S3 the generated at least one control command, and receiving S4 a confirmation signal indicating if the generated at least one control command represents the received natural language task statement.

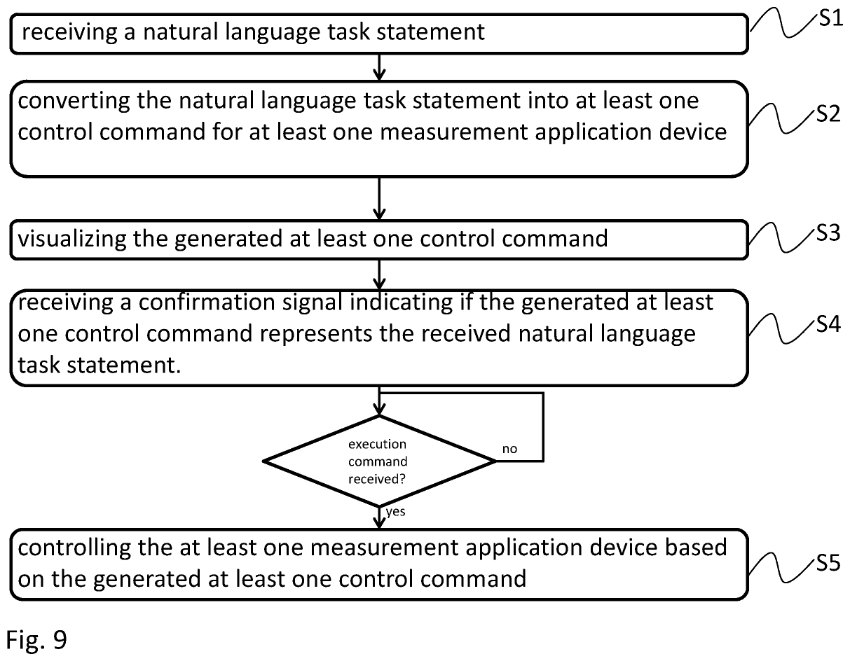

FIG. 9 shows a block diagram of another measurement application device control method. The method of FIG. 9 is based on the method of FIG. 8. Therefore, the method of FIG. 9 comprises receiving S1 a natural language task statement, converting S2 the natural language task statement into at least one control command for at least one measurement application device, visualizing S3 the generated at least one control command, and receiving S4 a confirmation signal indicating if the generated at least one control command represents the received natural language task statement.

The method of FIG. 9 further comprises a loop that waits until an execution command is received. After receiving the execution command, at least one measurement application device may be controlled based on the generated control commands.

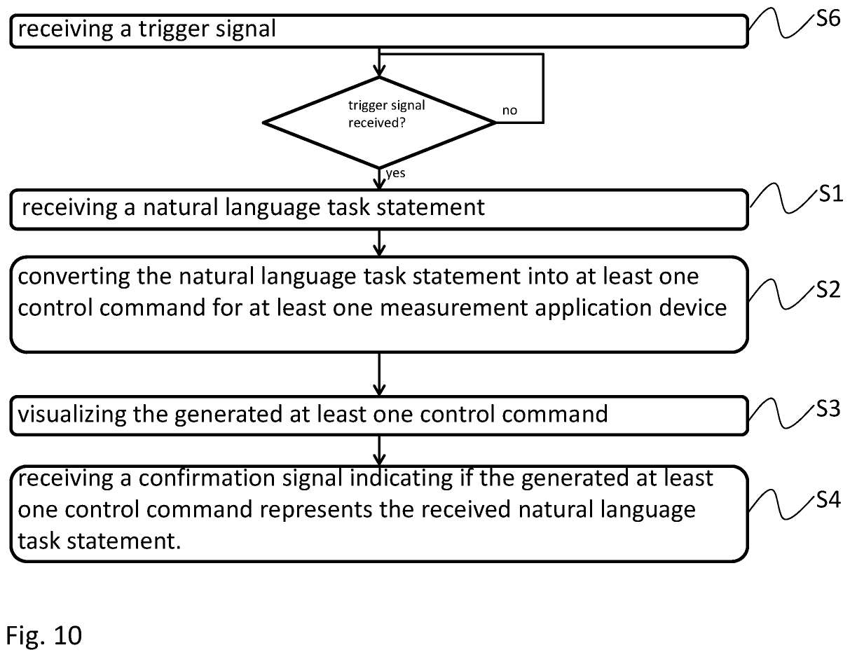

FIG. 10 shows a block diagram of another measurement application device control method. The method of FIG. 10 is based on the method of FIG. 8. Therefore, the method of FIG. 10 comprises receiving S1 a natural language task statement, converting S2 the natural language task statement into at least one control command for at least one measurement application device, visualizing S3 the generated at least one control command, and receiving S4 a confirmation signal indicating if the generated at least one control command represents the received natural language task statement.

The method of FIG. 10 further comprises the step S6 of receiving a trigger signal, and a loop that waits for receiving the trigger signal. Only after the trigger signal is received will the loop exit, and continue to the step S1 of receiving a natural language task statement.

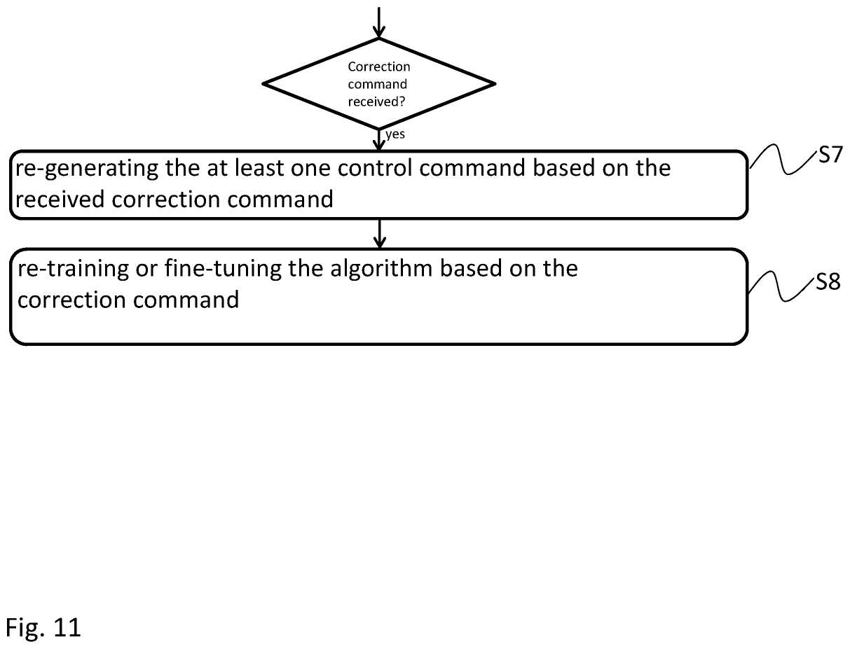

FIG. 11 shows a block diagram of another measurement application device control method. The method of FIG. 11 is based on the method of FIG. 8, although the steps S1-S4 are not explicitly shown.

The method of FIG. 11 further comprises verifying if a received user command is a correction command. If this is the case, the at least one control command is re-generated S7 based on the correction command. Further, as optional measure, the algorithm used for converting the natural language task statement into at least one control command may be fined-tuned or re-trained S8.

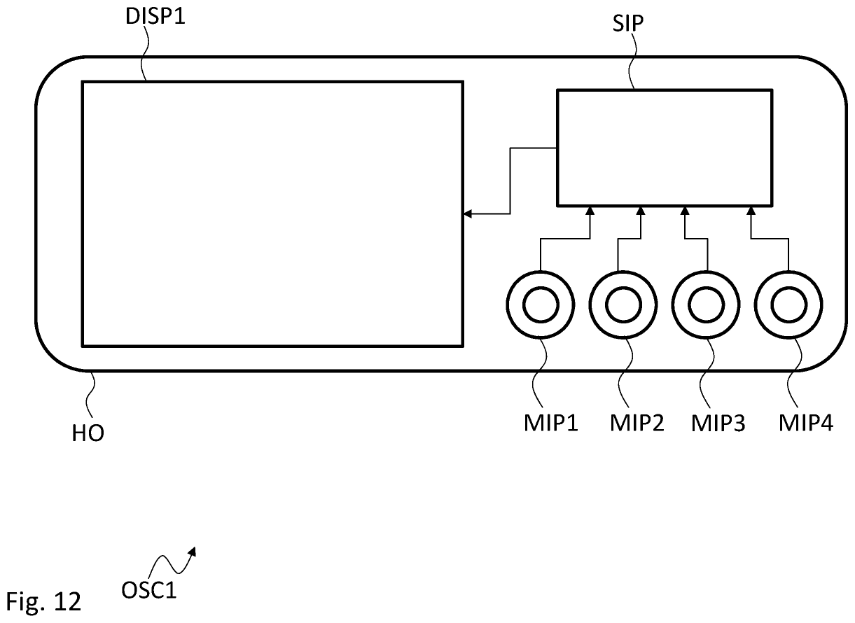

FIG. 12 shows a block diagram of an oscilloscope OSC1 that may be used with an embodiment of a measurement application device control system according to the present disclosure.

The oscilloscope OSC1 comprises a housing HO that accommodates four measurement inputs MIP1, MIP2, MIP3, MIP4 that are coupled to a signal processor SIP for processing any measured signals. The signal processor SIP is coupled to a display DISP1 for displaying the measured signals to a user.

Although not explicitly shown, it is understood, that the oscilloscope OSC1 may also comprise signal outputs that may also be coupled to the differential measurement probe. Such signal outputs may for example serve to output calibration signals. Such calibration signals allow calibrating the measurement setup prior to performing any measurement. The process of calibrating and correcting any measurement signals based on the calibration may also be called de-embedding and may comprise applying respective algorithms on the measured signals.

The signal processor SIP may implement all processing functions of a measurement application device control system according to the present disclosure, while an audio interface may be added to the oscilloscope OSC1 for receiving the natural language task statements. The display DISP1 may be used as the command visualizer. A touchscreen of the oscilloscope OSC1 may be used as user input device.

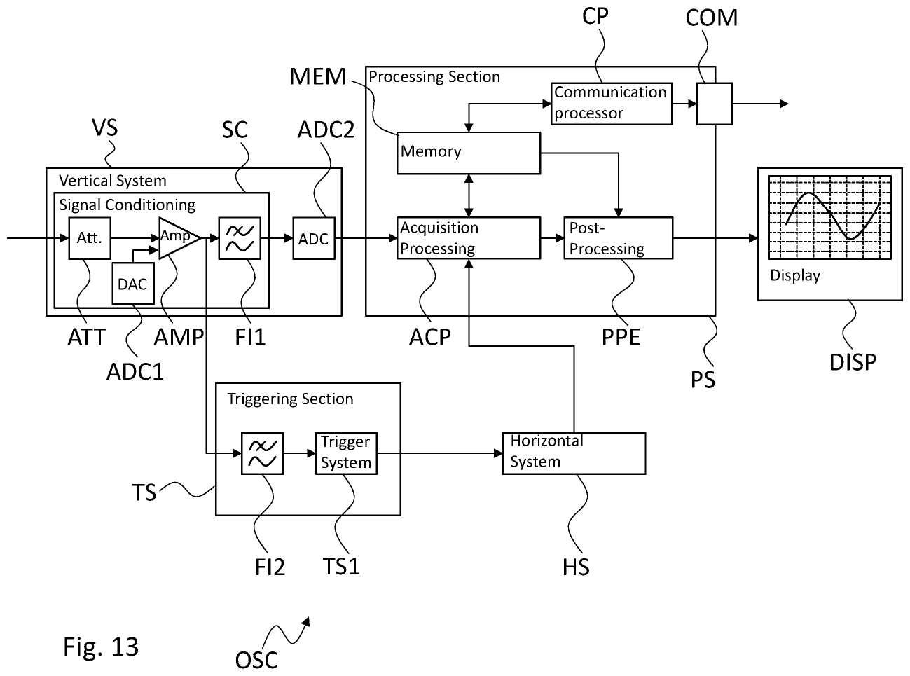

FIG. 13 shows a block diagram of an oscilloscope OSC that may be an implementation of a measurement application device for use with or in a measurement application device control system according to the present disclosure. The oscilloscope OSC is implemented as a digital oscilloscope. However, the present disclosure may also be implemented with any other type of oscilloscope.

The oscilloscope OSC exemplarily comprises five general sections, the vertical system VS, the triggering section TS, the horizontal system HS, the processing section PS and the display DISP. It is understood, that the partitioning into five general sections is a logical partitioning and does not limit the placement and implementation of any of the elements of the oscilloscope OSC in any way.

The vertical system VS mainly serves for offsetting, attenuating and amplifying a signal to be acquired. The signal may for example be modified to fit in the available space on the display DISP or to comprise a vertical size as configured by a user.

To this end, the vertical system VS comprises a signal conditioning section SC with an attenuator ATT and a digital-to-analog-converter DAC that are coupled to an amplifier AMP1. The amplifier AMP1 is coupled to a filter FI1, which in the shown example is provided as a low pass filter. The vertical system VS also comprises an analog-to-digital converter ADC1 that receives the output from the filter FI1 and converts the received analog signal into a digital signal.

The attenuator ATT and the amplifier AMP1 serve to scale the amplitude of the signal to be acquired to match the operation range of the analog-to-digital converter ADC1. The digital-to-analog-converter DAC1 serves to modify the DC component of the input signal to be acquired to match the operation range of the analog-to-digital converter ADC1. The filter FI1 serves to filter out unwanted high frequency components of the signal to be acquired.

The triggering section TS operates on the signal as provided by the amplifier AMP. The triggering section TS comprises a filter FI2, which in this embodiment is implemented as a low pass filter. The filter FI2 is coupled to a trigger system TS1.

The triggering section TS serves to capture predefined signal events and allows the horizontal system HS to e.g., display a stable view of a repeating waveform, or to simply display waveform sections that comprise the respective signal event. It is understood, that the predefined signal event may be configured by a user via a user input of the oscilloscope OSC.

Possible predefined signal events may for example include, but are not limited to, when the signal crosses a predefined trigger threshold in a predefined direction i.e., with a rising or falling slope. Such a trigger condition is also called an edge trigger. Another trigger condition is called “glitch triggering” and triggers, when a pulse occurs in the signal to be acquired that has a width that is greater than or less than a predefined amount of time.

In order to allow an exact matching of the trigger event and the waveform that is shown on the display DISP, a common time base may be provided for the analog-to-digital converter ADC1 and the trigger system TS1.

It is understood, that although not explicitly shown, the trigger system TS1 may comprise at least one of configurable voltage comparators for setting the trigger threshold voltage, fixed voltage sources for setting the required slope, respective logic gates like e.g., a XOR gate, and FlipFlops to generate the triggering signal.

The triggering section TS is exemplarily provided as an analog trigger section. It is understood, that the oscilloscope OSC may also be provided with a digital triggering section. Such a digital triggering section will not operate on the analog signal as provided by the amplifier AMP but will operate on the digital signal as provided by the analog-to-digital converter ADC1.

A digital triggering section may comprise a processing element, like a processor, a DSP, a CPLD, an ASIC or an FPGA to implement digital algorithms that detect a valid trigger event.

The horizontal system HS is coupled to the output of the trigger system TS1 and mainly serves to position and scale the signal to be acquired horizontally on the display DISP.

The oscilloscope OSC further comprises a processing section PS that implements digital signal processing and data storage for the oscilloscope OSC. The processing section PS comprises an acquisition processing element ACP that is couple to the output of the analog-to-digital converter ADC1 and the output of the horizontal system HS as well as to a memory MEM and a post processing element PPE.

The acquisition processing element ACP manages the acquisition of digital data from the analog-to-digital converter ADC1 and the storage of the data in the memory MEM. The acquisition processing element ACP may for example comprise a processing element with a digital interface to the analog-to-digital converter ADC2 and a digital interface to the memory MEM. The processing element may for example comprise a microcontroller, a DSP, a CPLD, an ASIC or an FPGA with respective interfaces. In a microcontroller or DSP, the functionality of the acquisition processing element ACP may be implemented as computer readable instructions that are executed by a CPU. In a CPLD or FPGA the functionality of the acquisition processing element ACP may be configured in to the CPLD or FPGA opposed to software being executed by a processor.

The processing section PS further comprises a communication processor CP and a communication interface COM.

The communication processor CP may be a device that manages data transfer to and from the oscilloscope OSC. The communication interface COM for any adequate communication standard like for example, Ethernet, WIFI, Bluetooth, NFC, an infra-red communication standard, and a visible-light communication standard.

The communication processor CP is coupled to the memory MEM and may use the memory MEM to store and retrieve data.

Of course, the communication processor CP may also be coupled to any other element of the oscilloscope OSC to retrieve device data or to provide device data that is received from the management server.

The post processing element PPE may be controlled by the acquisition processing element ACP and may access the memory MEM to retrieve data that is to be displayed on the display DISP. The post processing element PPE may condition the data stored in the memory MEM such that the display DISP may show the data e.g., as waveform to a user. The post processing element PPE may also realize analysis functions like cursors, waveform measurements, histograms, or math functions.

The display DISP controls all aspects of signal representation to a user, although not explicitly shown, may comprise any component that is required to receive data to be displayed and control a display device to display the data as required.

The elements of the processing section PS may implement all processing functions of a measurement application device control system according to the present disclosure, while an audio interface may be added to the oscilloscope OSC for receiving the natural language task statements. The display DISP may be used as the command visualizer.

It is understood, that even if it is not shown, the oscilloscope OSC may also comprise a user interface for a user to interact with the oscilloscope OSC. Such a user interface may comprise dedicated input elements like for example knobs and switches. At least in part the user interface may also be provided as a touch sensitive display device.

It is understood, that all elements of the oscilloscope OSC that perform digital data processing may be provided as dedicated elements. As alternative, at least some of the above-described functions may be implemented in a single hardware element, like for example a microcontroller, DSP, CPLD or FPGA. Generally, the above-describe logical functions may be implemented in any adequate hardware element of the oscilloscope OSC and not necessarily need to be partitioned into the different sections explained above.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### LIST OF REFERENCE SIGNS

100 measurement application device control system
101 natural language interface
102 natural language task statement
103 natural language converter
104 at least one control command
105 command visualizer
106 confirmation interface
207, 507 display device
208 diagram representation
310 device control interface
311, 711-1, 711-2, 711-3 measurement application device
312 execution command
415 trigger interface
416 trigger signal
518, 718 audio interface
519 audio converter
520 statement representation
623 algorithm
624 algorithm trainer
625 correction command
727 central processing element
728 network
729 microphone
730 touchscreen
OSC1 oscilloscope
HO housing
MIP1, MIP2, MIP3, MIP4 measurement input
SIP signal processing
DISP1 display
OSC oscilloscope
VS vertical system
SC signal conditioning
ATT attenuator
DAC1 analog-to-digital converter
AMP1 amplifier
FI1 filter
ADC1 analog-to-digital converter
TS triggering section
AMP2 amplifier
FI2 filter
TS1 trigger system
HS horizontal system
PS processing section
ACP acquisition processing element
MEM memory
PPE post processing element
DISP display

1. A measurement application device control system comprising:
a natural language interface configured to receive a natural language task statement;
a natural language converter coupled to the natural language interface, and configured to convert the natural language task statement into at least one control command for at least one measurement application device;
a command visualizer coupled to the natural language converter and configured to visualize the generated at least one control command; and
a confirmation interface configured to receive a confirmation signal indicating that the generated at least one control command represents the received natural language task statement.

2. The measurement application device control system according to claim 1, further comprising a device control interface configured to control the at least one measurement application device based on the generated at least one control command.

3. The measurement application device control system according to claim 2, wherein the device control interface is configured to control the at least one measurement application device after a respective execution command is received via at least one of the natural language interface and the confirmation interface.

4. The measurement application device control system according to claim 1, further comprising a trigger interface configured to receive a trigger signal and activate the natural language interface after receiving the trigger signal.

5. The measurement application device control system according to claim 1, wherein the natural language interface comprises an audio interface and an audio converter that is coupled to the audio interface and that is configured to convert a received audio signal into a statement representation that is processable by the natural language converter.

6. The measurement application device control system according to claim 1, wherein the natural language interface or the confirmation interface is configured to receive a correction command, and wherein the natural language converter is configured to re-generate the at least one control command based on the received correction command.

7. The measurement application device control system according to claim 1, wherein the natural language converter comprises an algorithm that comprises at least one of an artificial-intelligence-based algorithm, and a trained algorithm.

8. The measurement application device control system according to claim 7, further comprising an algorithm trainer, wherein the natural language interface is configured to receive a correction command, and the algorithm trainer is configured to re-train or fine-tune the algorithm based on the correction command.

9. The measurement application device control system according to claim 1, further comprising a display device configured to display a representation of the generated at least one control command.

10. The measurement application device control system according to claim 9, wherein the representation of the generated at least one control command comprises at least one of a text representation, a flow diagram, or a block diagram.

11. The measurement application device control system according to claim 1, further comprising a central processing element, wherein at least one of the natural language interface, the natural language converter, the command visualizer, and the confirmation interface are at least in part provided as computer programs comprising computer readable instructions that are executed by the central processing element.

12. A measurement application device control method comprising:
receiving a natural language task statement;
converting the natural language task statement into at least one control command for at least one measurement application device;
visualizing the generated at least one control command; and
receiving a confirmation signal indicating if the generated at least one control command represents the received natural language task statement.

13. The measurement application device control method according to claim 12, further comprising controlling the at least one measurement application device based on the generated at least one control command.

14. The measurement application device control method according to claim 13, wherein controlling the at least one measurement application device is performed after a respective execution command is received via at least one of a natural language interface or a confirmation interface, or a dedicated confirmation interface.

15. The measurement application device control method according to claim 12, further comprising receiving a trigger signal and activating the receiving of the natural language task statement after receiving the trigger signal.

16. The measurement application device control method according to claim 12, wherein the natural language task statement is received as an audio statement and is converted into a statement representation that is automatically processable.

17. The measurement application device control method according to claim 12, further comprising receiving a correction command, and re-generating the at least one control command based on the received correction command.

18. The measurement application device control method according to claim 12, wherein converting is performed with at least one of an artificial-intelligence-based algorithm, and a trained algorithm.

19. The measurement application device control method according to claim 18, further comprising receiving a correction command, and re-training or fine-tuning the artificial-intelligence-based algorithm based on the correction command.

20. The measurement application device control method according to claim 12, further comprising displaying a representation of the generated at least one control command.

21. The measurement application device control method according to claim 20, wherein the representation of the generated at least one control command comprises at least one of a text representation, a flow diagram, or a block diagram.
